(19) United States
(12) Patent Application Publication
(10) Pub. No.: US 2021/0282341 A1
(43) Pub. Date: Sep. 16, 2021

(54) WIRELESS IRRIGATION CONTROL DEVICE AND SYSTEM

(71) Applicant: AEON MATRIX INC., Taipei City (TW)

(72) Inventor: MING-JE TSAI, Taipei City (TW)

(21) Appl. No.: 16/815,014

(22) Filed: Mar. 11, 2020

(51) Int. Cl. A01G 25/16; F16K 31/02

(52) U.S. Cl. CPC A01G 25/16; F16K 31/02

(57) ABSTRACT

An irrigation control device signally connected with a central controller wirelessly for controlling a valve to control water supplied to a sprinkler. The irrigation control device includes a power supply module and a wireless module. The power supply module receives a local power for driving the valve. The wireless module is capable of being signally connected with the central controller wirelessly to receive a valve control signal from the central controller.

### BACKGROUND OF THE INVENTION

### 1. Field of the Invention

The invention is related to an irrigation control system and, in particular, to an irrigation control system with a wireless communication capability.

### 2. Description of the Related Art

A conventional irrigation control system includes a central controller, a plurality of sprinklers, and a plurality of valves each corresponding to a respective sprinkler to control the water supply to the sprinklers. To supply electric power to control the valves, electric wires are provided to connect the central controller and the valves. The central controller may send valve control signals via the electric wires to control the valves according to a predetermined watering schedule.

Since the valves cannot be driven by local power supply but electric power supplied from the central controller via the electric wires, for a large irrigation area one needs to deploy long wires for the valves far away from the central controller. This significantly increases the complexity and costs for deploying and maintaining the system.

### BRIEF SUMMARY OF THE INVENTION

An irrigation control device signally connected with a central controller to control a valve. The valve controls water supplied to a sprinkler. The irrigation control device includes a power supply module and a wireless module. The power supply module receives a local power for driving the valve, and the wireless module is signally connected with the central controller wirelessly for receiving a valve control signal from the central controller.

The disclosure also provides an irrigation control system including a central controller and a plurality of irrigation control devices. The irrigation control devices are signally connected with the central controller, and each irrigation control device controls a corresponding valve. Each irrigation control device includes a power supply module and a wireless module. The power supply module receives a local power for driving the valve, and the wireless module is signally connected with the central controller wirelessly for receiving a valve control signal from the central controller.

In one embodiment, the wireless module may be an LPWAN module, and the local power may be 110V AC main.

In one embodiment, the irrigation control device further includes a processing unit for driving the valve using electric power from the power module according to the valve control signal. The valve control signal may include a device identification code corresponding to the irrigation control device, and the valve is driven when the device identification code matches a preset code of the irrigation control device.

According to the disclosure, since the electric power required to drive the valve is from the local power supply, and the valve control signals are sent wirelessly from the central controller, it is not necessary to deploy long electric wires to connect the irrigation control device to the central controller. Therefore, the complexity and costs of deploying and maintaining the system can be significantly reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic diagram showing an irrigation control device according to an embodiment of the invention.

FIG. 2 is a schematic diagram showing an irrigation control system according to another embodiment of the invention.

### DETAILED DESCRIPTION OF THE INVENTION

The present invention will now be described with some preferred embodiments thereof and by referring to the accompanying drawings.

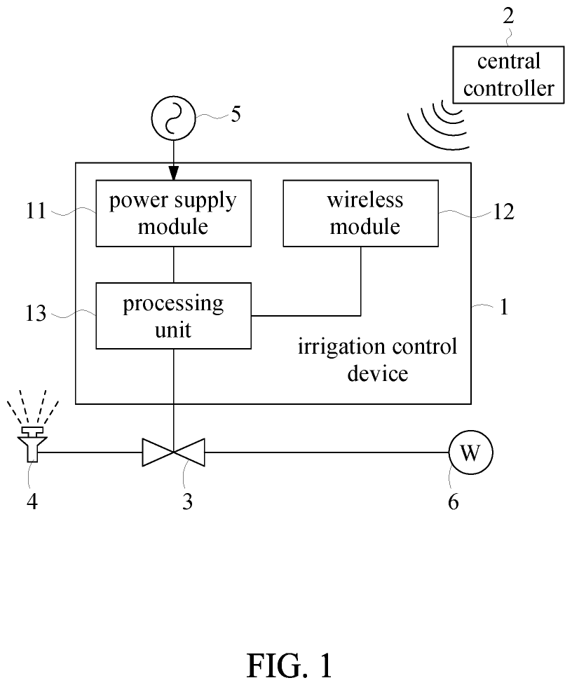

Referring to FIG. 1, the irrigation control device 1 according to an embodiment of the invention includes a power supply module 11, a wireless module 12 and a processing unit 13. The processing unit 13 is electrically connected with a valve 3, which controls the water supply of from a water source 6 to a sprinkler 4.

The power supply module 11 is connected with a local power supply 5, and converts the local power into the power required by the processing unit 13 to drive the valve 3. In one example, the power supply module 11 may receive power from a local 110V AC main, and convert it into 19V DC required by the processing unit 13 to drive the valve 3. In another example, the local power supply may be a battery, and the power supply module 11 uses the DC voltage from the battery to drive the valve 3.

The wireless module 12 has an antenna and circuitry necessary to establish a signal connection with a central controller 2 wirelessly. For example, the wireless module may be an LPWAN (Low Power Wide Area Network) module, which is designed to allow long-range communications at a low bit rate. The operating range of an LPWAN module varies from a few kilometers in urban areas to over 10 km in rural settings, and the power consumption is optimized so that it can run on small, inexpensive batteries for more than 10 years. LPWAN's simplified protocols reduce complexity in hardware design, and thus lower device costs. In some embodiments, the wireless module 12 may use LoRa (Long Range) technology or UNB-based SigFox technology for LPWAN communication.

The processing unit 13 controls the valve 3 according to the valve control signal sent from the central controller 2 and received by the wireless module 12, and has driving circuitry to drive the valve 3 using the electric power from the power module 11. For example, the central controller 2 may send valve control signals according to a predetermined watering schedule to control the valve 3 during a predetermine time period. When the wireless module 2 receives the valve control signals, the processing unit 13 drives to turn on the valve 3 to supply water from the water source 6 to the sprinkler 4 for irrigation purposes, and turns off the valve 3 to stop supplying water to the valve 3 at the end of the predetermine time period.

The power supply module 11, the wireless module 12 and the processing unit 13 may be implemented on the same circuit board within the irrigation control device 1, or on separate circuit boards and connected with each other via physical connectors. For example, the irrigation control device 1 may have a main circuit board on which the power supply module 11 and the processing unit 13 are disposed, and an auxiliary circuit board on which the wireless module 12 is disposed. The main circuit board and the auxiliary circuit board have connectors to establish electric connection between them.

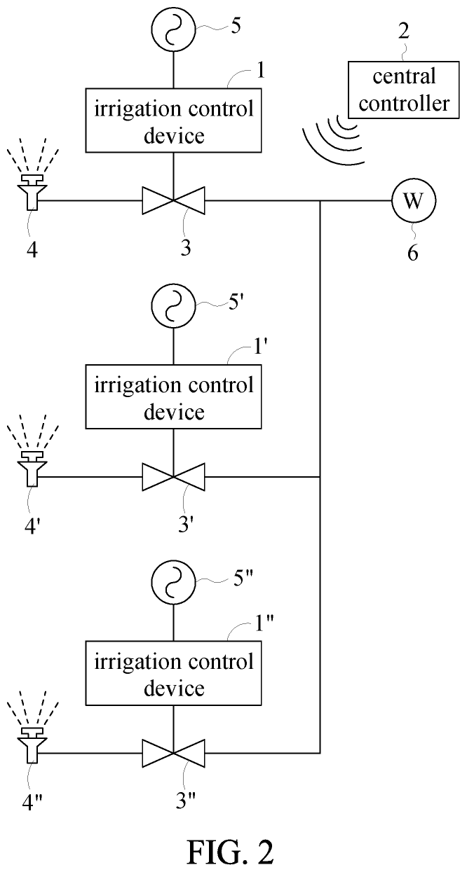

Referring to FIG. 2, according to another embodiment, an irrigation control system includes the central controller 2 and multiple irrigation control devices. The three irrigation control devices 1, 1′ and 1″ shown in FIG. 2 have the same configuration, except that they have different device identification codes. Each irrigation control device is connected with their local power supply 5, 5′ and 5″, respectively, and controls corresponding valves 3, 3′, 3″ respectively to supply water from the water source 6 to different sprinklers 4, 4′ and 4″, respectively.

The central controller 2 may send a valve control signal including the device identification code of one of the irrigation control devices 1, 1′ and 1″. Upon receiving the valve control signal, each of the irrigation control devices 1, 1′ and 1″ compares the device identification code included in the valve control signal with its own preset code, and drives its corresponding valve 3, 3′ or 3″ when the device identification code matches the preset code. The central controller 2 may also broadcast a valve control signal to all the irrigation control devices 1, 1′ and 1″ to drive the valves 3, 3′ and 3″ at the same time.

The central controller 2 may control the irrigation control devices 1, 1′ and 1″ according to a predetermined watering schedule, or the sensing result of the sensors deployed within the irrigation area. For example, the central controller 2 may retrieve weather information of the irrigation area, such as recent temperature and rainfall data, to determine a watering schedule for the irrigation area and control the irrigation control devices 1, 1′ and 1″ accordingly. The central controller 2 may also store the corresponding relationships between the irrigation control devices 1, 1′ and 1″ and multiple humidity sensors deployed within the irrigation area, and control the irrigation control devices 1, 1′ and 1″ and the sensing results of the humidity sensors.

According to the disclosure, since the electric power required to drive the valve is from the local power supply, and the valve control signals are sent wirelessly from the central controller, it is not necessary to deploy long electric wires to connect the irrigation control device to the central controller. Therefore, the complexity and costs of deploying and maintaining the system can be significantly reduced.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

What is claimed is:

1. An irrigation control device signally connected with a central controller wirelessly for controlling a valve to control water supplied to a sprinkler, the irrigation control device comprising:
a power supply module for receiving a local power for driving the valve; and
a wireless module for being signally connected with the central controller wirelessly to receive a valve control signal from the central controller.

2. The irrigation control device according to claim 1, wherein the wireless module is an LPWAN module.

3. The irrigation control device according to claim 1, wherein the local power is 110V AC main.

4. The irrigation control device according to claim 1, further comprising:
a processing unit for driving the valve using electric power from the power module according to the valve control signal.

5. The irrigation control device according to claim 1, wherein the valve control signal includes a device identification code corresponding to the irrigation control device.

6. The irrigation control device according to claim 5, wherein the valve is driven when the device identification code matches a preset code of the irrigation control device.

7. An irrigation control system for controlling a plurality of valves, the valves controlling water supplied to a plurality of sprinklers, the irrigation control system comprising:
a central controller; and
a plurality of irrigation control devices for being signally connected with the central controller, each irrigation control device controlling a corresponding valve and comprising:
a power supply module for receiving a local power for driving a corresponding valve among the valves; and
a wireless module signally connected with the central controller wirelessly for receiving a valve control signal from the central controller.

8. The irrigation control system according to claim 7, wherein the wireless module is an LPWAN module.

9. The irrigation control system according to claim 7, wherein the local power is 110V AC main.

10. The irrigation control system according to claim 7, wherein each irrigation control device further comprises:
a processing unit for driving the corresponding valve using electric power from the power module according to the valve control signal.

11. The irrigation control system according to claim 7, wherein the valve control signal includes a device identification code corresponding to one of the irrigation control devices.

12. The irrigation control system according to claim 11, wherein the corresponding valve is driven when the device identification code matches a preset code of one of the irrigation control devices.
